(19) United States
(12) Patent Application Publication
(10) Pub. No.: US 2026/0144282 A1
(43) Pub. Date: May 28, 2026

(54) CRYSTALLINE COMPLEX, METHOD FOR PRODUCING THEREOF, AND COMPOSITION

(71) Applicant: KANEKA CORPORATION, Osaka (JP)

(72) Inventors: Hideo Kawachi, Hyogo (JP); Masashi Yoshida, Hyogo (JP)

(73) Assignee: KANEKA CORPORATION, Osaka (JP)

(21) Appl. No.: 19/430,798

(22) Filed: Dec. 23, 2025

Related U.S. Application Data
(63) Continuation of application No. PCT/JP2024/020983, filed on Jun. 10, 2024.

(30) Foreign Application Priority Data
Jun. 29, 2023 (JP) 2023-107092

(51) Int. Cl. A23L 27/30; A23L 29/00

(52) U.S. Cl. CPC A23L 27/31; A23L 29/05

(57) ABSTRACT

A novel crystalline complex of nicotinamide mononucleotide that is stable and highly safe is provided. The crystalline complex contains nicotinamide mononucleotide and a phenylalanine-based compound. The crystalline complex has L-phenylalanine or aspartame as the phenylalanine-based compound. The crystalline complex having L-phenylalanine as the phenylalanine-based compound has peaks at diffraction angles (2θ) of 19.7±0.2°, 26.4±0.2°, and 32.8±0.2° in a diffraction pattern of powder X-ray diffraction measured with a Cu-Kα ray as an X-ray source. The crystalline complex having aspartame as the phenylalanine-based compound has peaks at diffraction angles (2θ) of 7.0±0.2°, 10.7±0.2°, 14.4±0.2°, and 29.1±0.2° in a diffraction pattern of powder X-ray diffraction measured with a Cu-Kα ray as an X-ray source.

### TECHNICAL FIELD

One or more embodiments of the present invention relate to a novel crystalline complex of nicotinamide mononucleotide, a method for producing the crystalline complex, and a composition containing the crystalline complex.

### BACKGROUND

Nicotinamide mononucleotide (NMN) is a type of biochemical substance that naturally occurs in a biological body and has recently attracted attention as a substance with the potential to inhibit aging and extend healthy life expectancy. Patent Document 1 discloses an amino acid salt of nicotinamide mononucleotide, and Patent Document 2 discloses a nicotinamide mononucleotide-isonicotinoid cocrystal.

### PATENT DOCUMENTS

Patent Document 1: Japanese Translation of PCT International Publication No. 2021-524501

Patent Document 2: Japanese Unexamined Patent Application Publication No. 2023-001065

The amino acid salt of nicotinamide mononucleotide disclosed in Patent Document 1 is highly hygroscopic, possibly due to its crystal structure, and therefore has been difficult to handle when used in foods, health foods, supplements, pharmaceuticals, and the like. The nicotinamide mononucleotide-isonicotinoid cocrystal disclosed in Patent Document 2 includes isonicotinoid that is not listed in Japanese Pharmaceutical Excipients or Japan's Specifications and Standards for Food Additives and has not been used in food. When the nicotinamide mononucleotide-isonicotinoid cocrystal is used in foods, health foods, supplements, pharmaceuticals, and the like, safety has not been secured.

One or more embodiments of the present invention have been made in view of the above-mentioned circumstances, and a novel crystalline complex of nicotinamide mononucleotide, the crystalline complex being stable without deliquescing, being composed of components that have been used in food, and thus being safer is provided.

The present inventors made intensive studies to solve the above and as a result, found that nicotinamide mononucleotide can form a crystalline complex with only a limited number of compounds among many compounds, and that such compounds include L-phenylalanine and aspartame, which are safe and have been used in food, and that when nicotinamide mononucleotide forms a crystalline complex with these compounds, the safety and stability of the crystalline complex can be improved. One or more embodiments of the present invention have been completed based on these findings.

### SUMMARY

That is, the summary of one or more embodiments of the present invention is as follows.

A crystalline complex of nicotinamide mononucleotide and a phenylalanine-based compound,
wherein the phenylalanine-based compound is L-phenylalanine, and the crystalline complex has peaks at diffraction angles (2θ) of 19.7±0.2°, 26.4±0.2°, and 32.8±0.2° in a diffraction pattern of powder X-ray diffraction measured using a Cu-Kα ray as an X-ray source, or
wherein the phenylalanine-based compound is aspartame, and the crystalline complex has peaks at diffraction angles (2θ) of 7.0±0.2°, 10.7±0.2°, 14.4±0.2°, and 29.1±0.2° in a diffraction pattern of powder X-ray diffraction measured using a Cu-Kα ray as an X-ray source.

The crystalline complex according to [1], wherein a mole ratio of the nicotinamide mononucleotide and the phenylalanine-based compound (nicotinamide mononucleotide:phenylalanine-based compound) in the crystalline complex is 1:0.7 to 1:1.3.

The crystalline complex according to [1] or [2], wherein the phenylalanine-based compound is L-phenylalanine, and the crystalline complex has at least one selected from the following characteristics (i) to (iii) in a diffraction pattern of powder X-ray diffraction measured using a Cu-Kα ray as an X-ray source:
(i) a ratio of peak intensities at diffraction angles (2θ) of 19.7±0.2° and 26.4±0.2° (peak intensity at 26.4±0.2°/peak intensity at 19.7±0.2°) is 0.35 or more and 0.90 or less;
(ii) a ratio of peak intensities at diffraction angles (2θ) of 19.7±0.2° and 32.8±0.2° (peak intensity at 32.8±0.2°/peak intensity at 19.7±0.2°) is 0.10 or more and 0.60 or less; and
(iii) a ratio of peak intensities at diffraction angles (2θ) of 26.4±0.2° and 32.8±0.2° (peak intensity at 32.8±0.2°/peak intensity at 26.4±0.2°) is 0.30 or more and 0.80 or less.

The crystalline complex according to [1] or [2], wherein the phenylalanine-based compound is aspartame, and the crystalline complex has at least one selected from the following characteristics (a) to (f) in a diffraction pattern of powder X-ray diffraction measured using a Cu-Kα ray as an X-ray source:
(a) a ratio of peak intensities at diffraction angles (2θ) of 10.7±0.2° and 7.0±0.2° (peak intensity at 7.0±0.2°/peak intensity at 10.7±0.2°) is 0.30 or more and 0.70 or less;
(b) a ratio of peak intensities at diffraction angles (2θ) of 10.7±0.2° and 14.4±0.2° (peak intensity at 14.4±0.2°/peak intensity at 10.7±0.2°) is 0.05 or more and 0.50 or less;
(c) a ratio of peak intensities at diffraction angles (2θ) of 10.7±0.2° and 29.1±0.2° (peak intensity at 29.1±0.2°/peak intensity at 10.7±0.2°) is 0.05 or more and 0.50 or less;
(d) a ratio of peak intensities at diffraction angles (2θ) of 7.0±0.2° and 14.4±0.2° (peak intensity at 14.4±0.2°/peak intensity at 7.0±0.2°) is 0.30 or more and 0.80 or less;
(e) a ratio of peak intensities at diffraction angles (2θ) of 7.0±0.2° and 29.1±0.2° (peak intensity at 29.1±0.2°/peak intensity at 7.0±0.2°) is 0.30 or more and 0.70 or less; and
(f) a ratio of peak intensities at diffraction angles (2θ) of 14.4±0.2° and 29.1±0.2° (peak intensity at 29.1±0.2°/peak intensity at 14.4±0.2°) is 0.50 or more and 1.05 or less.

A composition comprising the crystalline complex according to any one of [1] to [4].

A method for producing the crystalline complex according to any one of [1] to [4], the method comprising precipitating a crystalline complex from a mixed solution in which nicotinamide mononucleotide and a phenylalanine-based compound are dissolved.

The method according to [6], comprising precipitating a crystalline complex of nicotinamide mononucleotide and a phenylalanine-based compound from a mixed solvent of water and a water-miscible organic solvent.

The method according to [6] or [7], wherein a mole ratio of the nicotinamide mononucleotide to the phenylalanine-based compound in the mixed solution (nicotinamide mononucleotide:phenylalanine-based compound) is 1:0.7 to 1:1.3.

The method according to [7], wherein the water-miscible organic solvent comprises at least one selected from the group consisting of monohydric alcohols, ketones, and nitriles.

The method according to [7] or [9], wherein, with respect to a mixing ratio of the water to the water-miscible organic solvent in the mixed solvent, an amount of the water-miscible organic solvent relative to 1 volume of the water is 0.5 volumes or more and 50 volumes or less.

According to one or more embodiments of the present invention, it is possible to provide a novel crystalline complex of nicotinamide mononucleotide, the crystalline complex being safe and having excellent stability, and a method for producing the same.

### BRIEF DESCRIPTION OF THE DRAWINGS

FIG. 1 shows a powder X-ray diffraction diagram of the crystal obtained in Example 1.

FIG. 2 shows a powder X-ray diffraction diagram of the crystal obtained in Example 2.

FIG. 3 shows a powder X-ray diffraction diagram of the crystal obtained in Example 3.

FIG. 4 shows a powder X-ray diffraction diagram of the crystal obtained in Example 4.

### DETAILED DESCRIPTION

The crystalline complex of nicotinamide mononucleotide according to one or more embodiments of the present invention is a complex of nicotinamide mononucleotide with a phenylalanine-based compound that has been used in food and is safe, and can be characterized using powder X-ray diffraction (PXRD). Specifically, the crystalline complex is a crystalline complex of nicotinamide mononucleotide and L-phenylalanine that has peaks at diffraction angles (2θ) of 19.7±0.2°, 26.4±0.2°, and 32.8±0.2° in powder X-ray diffraction using a Cu-Kα ray, or a crystalline complex of nicotinamide mononucleotide and aspartame (N-(L-α-aspartyl)-L-phenylalanine 1-methyl ester) that has peaks at diffraction angles (2θ) of 7.0±0.2°, 10.7±0.2°, 14.4±0.2°, and 29.1±0.2° in powder X-ray diffraction using a Cu-Kα ray.

The crystalline complex according to one or more embodiments of the present invention is safe and has excellent stability, is therefore easy to handle, and is advantageous for use in foods, health foods, supplements, pharmaceuticals, and the like.

In powder X-ray diffraction, the intensity of a diffraction peak may vary depending on a pretreatment method for measurement, a sample-setting method, and other factors. This is called orientation or preferred orientation. This influence may cause changes in the intensity of a characteristic peak and in turn the intensity ratio with other peaks, so that the powder x-ray diffraction pattern may seem to be different. However, as long as the position of the characteristic peak, that is, the position of the diffraction angle (2θ), is the same, a case where there is a change in the peak intensity is still essentially within the scope of one or more embodiments of the present invention. In other words, in determining the identity of crystal by powder X-ray diffraction, the position of the diffraction angle (2θ) and the similarity of the overall pattern are important. In addition, an error of ±0.2° of a diffraction angle (2θ) in powder X-ray diffraction is generally within an allowable error range. When a baseline of a diffraction pattern of powder X-ray diffraction is disturbed due to the influence of amorphous matter or the like, it is preferable to correct the baseline to eliminate the influence of the amorphous matter or the like.

In consideration of the above-mentioned influences, for example, the crystalline complex of nicotinamide mononucleotide and L-phenylalanine may have at least one of the following characteristics (i) to (iii) in powder X-ray diffraction using a Cu-Kα ray:
(i) the ratio of peak intensities at diffraction angles (2θ) of 19.7±0.2° and 26.4±0.2° (peak intensity at 26.4±0.2°/peak intensity at 19.7±0.2°) may be 0.35 or more and 0.90 or less, 0.40 or more and 0.80 or less, or 0.45 or more and 0.70 or less;
(ii) the ratio of peak intensities at diffraction angles (2θ) of 19.7±0.2° and 32.8±0.2° (peak intensity at 32.8±0.2°/peak intensity at 19.7±0.2°) may be 0.10 or more and 0.60 or less, 0.15 or more and 0.50 or less, or 0.20 or more and 0.45 or less; and
(iii) the ratio of peak intensities at diffraction angles (2θ) of 26.4±0.2° and 32.8±0.2° (peak intensity at 32.8±0.2°/peak intensity at 26.4±0.2°) may be 0.30 or more and 0.80 or less, 0.35 or more and 0.70 or less, or 0.40 or more and 0.65 or less.

The crystalline complex of nicotinamide mononucleotide and L-phenylalanine may have two selected from the above characteristics (i) to (iii), or may have the above three characteristics (i) to (iii).

Furthermore, in consideration of the above-mentioned influences, for example, the crystalline complex of nicotinamide mononucleotide and aspartame may have at least one of the following characteristics (a) to (f) in powder X-ray diffraction using a Cu-Kα ray:
(a) the ratio of peak intensities at diffraction angles (2θ) of 10.7±0.2° and 7.0±0.2° (peak intensity at 7.0±0.2°/peak intensity at 10.7±0.2°) may be 0.30 or more and 0.70 or less, 0.35 or more and 0.65 or less, or 0.40 or more and 0.60 or less;
(b) the ratio of peak intensities at diffraction angles (2θ) of 10.7±0.2° and 14.4±0.2° (peak intensity at 14.4±0.2°/peak intensity at 10.7±0.2°) may be 0.05 or more and 0.50 or less, 0.10 or more and 0.40 or less, or 0.15 or more and 0.35 or less;
(c) the ratio of peak intensities at diffraction angles (2θ) of 10.7±0.2° and 29.1±0.2° (peak intensity at 29.1±0.2°/peak intensity at 10.7±0.2°) may be 0.05 or more and 0.50 or less, 0.10 or more and 0.40 or less, or 0.15 or more and 0.35 or less;
(d) the ratio of peak intensities at diffraction angles (2θ) of 7.0±0.2° and 14.4±0.2° (peak intensity at 14.4±0.2°/peak intensity at 7.0±0.2°) may be 0.30 or more and 0.80 or less, 0.35 or more and 0.70 or less, or 0.40 or more and 0.65 or less;
(e) the ratio of peak intensities at diffraction angles (2θ) of 7.0±0.2° and 29.1±0.2° (peak intensity at 29.1±0.2°/peak intensity at 7.0±0.2°) may be 0.30 or more and 0.70 or less, 0.35 or more and 0.65 or less, or 0.40 or more and 0.60 or less; and
(f) the ratio of peak intensities at diffraction angles (2θ) of 14.4±0.2° and 29.1±0.2° (peak intensity at 29.1±0.2°/peak intensity at 14.4±0.2°) may be 0.50 or more and 1.05 or less, 0.60 or more and 1.00 or less, or 0.70 or more and 0.95 or less.

The crystalline complex of nicotinamide mononucleotide and aspartame may have two or more selected from the above characteristics (a) to (f), may have four or more selected from the above characteristics (a) to (f), or may have the above six characteristics (a) to (f).

In the crystalline complex, the mole ratio of nicotinamide mononucleotide to a phenylalanine-based compound (L-phenylalanine or aspartame) (nicotinamide mononucleotide:phenylalanine-based compound) may be 1:0.7 to 1:1.3, 1:0.75 to 1:1.2, or 1:0.8 to 1:1.1. The mole ratio of nicotinamide mononucleotide to a phenylalanine-based compound in the crystalline complex can be calculated by measuring the content of nicotinamide mononucleotide in the crystalline complex using high performance liquid chromatography (HPLC).

The crystalline complex according to one or more embodiments of the present invention is stable against moisture and may also be stable against heat by virtue of its specific crystal structure. Therefore, when the crystalline complex according to one or more embodiments of the present invention is used as a raw material, it does not deliquesce during the manufacturing process or storage and thus is easy to handle. Moreover, since the crystal structure is less prone to change during the manufacturing process or storage, it is possible to manufacture products (foods, health foods, supplements, pharmaceuticals, and the like) that can maintain uniform qualities.

The crystalline complex of nicotinamide mononucleotide according to one or more embodiments of the present invention can be produced, for example, by a method comprising a step of preparing a mixed solution in which nicotinamide mononucleotide and a phenylalanine-based compound (L-phenylalanine or aspartame) are dissolved, and a step of precipitating a crystalline complex from the mixed solution.

A solvent used in the mixed solution may be at least one selected from among water and a water-miscible organic solvent, and may be a single solvent or a mixed solvent, and may be a mixed solvent. When a single solvent is used, the solvent may be water; and when a mixed solvent is used, the solvent may be a mixed solvent of water and a water-miscible organic solvent. The water-miscible organic solvent means an organic solvent capable of mixing with water.

Examples of the water-miscible organic solvent include monohydric alcohols such as methanol, ethanol, n-propanol, isopropanol, and n-butanol; ketones such as acetone, methyl ethyl ketone, and methyl isobutyl ketone; ethers such as tetrahydrofuran and 1,4-dioxane; nitriles such as acetonitrile and propionitrile; amides such as N, N-dimethylformamide; and sulfoxides such as dimethyl sulfoxide. These solvents may be used alone or in combination of two or more. In order to obtain a crystalline complex having a desired crystal structure with high efficiency, as the water-miscible organic solvent, monohydric alcohols, ketones, and nitriles are preferable, monohydric alcohols having 1 to 5 carbon atoms, ketones having 3 to 5 carbon atoms, and nitriles having 2 to 5 carbon atoms are more preferable, monohydric alcohols having 1 to 4 carbon atoms, ketones having 3 to 4 carbon atoms, and nitrile having 2 to 4 carbon atoms are even more preferable, and acetonitrile is still more preferable. When two or more water-miscible organic solvents are used, the amount of a nitrile (preferably acetonitrile) in the total amount of the water-miscible organic solvents may be 50 mass % or more, 70 mass % or more, or 80 mass % or more, and the upper limit thereof may be, for example, 99.9 mass %.

When a solvent used in the mixed solution is a mixed solvent of water and a water-miscible organic solvent, with respect to a mixing ratio of water to the water-miscible organic solvent (the total amount when two or more water-miscible organic solvents are used) in the mixed solvent, the amount of the water-miscible organic solvent relative to 1 volume of water may be 0.5 volumes or more, 0.7 volumes or more, or 0.9 volumes or more in order to obtain a crystalline complex having a desired crystal structure with high efficiency. Although there is no particular upper limit, the amount of the water-miscible organic solvent to 1 volume of water may be, for example, 50 volumes or less.

The amount (volume) of the solvent (preferably a mixed solvent of water and acetonitrile at a volume ratio of 1:1) used in the mixed solution may be 1 to 50 times (ml/mmol), 2 to 40 times (ml/mmol), or 2.5 to 30 times (ml/mmol) the molar amount of nicotinamide mononucleotide in order to obtain a crystalline complex having a desired crystal structure with high efficiency.

The mole ratio of nicotinamide mononucleotide to the phenylalanine-based compound (nicotinamide mononucleotide:phenylalanine-based compound) in the mixed solution may be 1:0.7 to 1:1.3, 1:0.75 to 1:1.2, or 1:0.8 to 1:1.1 in order to obtain a crystalline complex having a desired crystal structure with high efficiency.

The mixing for preparing the mixed solution can be performed using a known or conventional device under known or conventional conditions.

The mixing for preparing the mixed solution may be performed at room temperature or under heating. The mixing temperature may be 10 to 80° C., 15 to 70° C., or 20 to 60° C. in order to obtain a crystalline complex having a desired crystal structure with high efficiency.

The mixed solution may be prepared, for example, by the following preparation procedure:
(A) nicotinamide mononucleotide and a phenylalanine-based compound may be dissolved in water, and then a water-miscible organic solvent may be added thereto; or
(B) nicotinamide mononucleotide and a phenylalanine-based compound may be added to a mixed solvent of water and a water-miscible organic solvent to create a supersaturated state.

Specifically, in the preparation procedure (A), it is preferable that nicotinamide mononucleotide and a phenylalanine-based compound be first dissolved in water, the volume of which may be 1 to 50 times (ml/mmol), or 5 to 30 times (ml/mmol), relative to the molar amount of nicotinamide mononucleotide, and then that a water-miscible organic solvent be gently added to the resulting solution and mixed. As to the “gently added”, it is preferable to add dropwise preferably for an addition period of 10 minutes or more. The addition period of the water-miscible organic solvent may be from 10 to 200 minutes, from 20 to 180 minutes, or from 30 to 150 minutes.

Specifically, in the preparation procedure (B), it is preferable that nicotinamide mononucleotide in an amount exceeding the saturated solubility be first added to a mixed solvent of water and a water-miscible organic solvent and dissolved, followed by removing the undissolved residue, and then that a phenylalanine-based compound in an amount exceeding the saturated solubility be added to the resulting solution and dissolved, followed by removing the undissolved residue, to obtain a mixed solution as a saturated solution. It is more preferable that nicotinamide mononucleotide and a phenylalanine-based compound be further added to the saturated solution to obtain a mixed solution. When nicotinamide mononucleotide and a phenylalanine-based compound are further added to the saturated solution, the amount (molar amount) of nicotinamide mononucleotide added to the saturated solution may be 0.01 to 5 times (mmol/ml), 0.03 to 2 times (mmol/ml), or 0.05 to 1 time (mmol/ml) relative to the volume of water in the mixed solvent. When nicotinamide mononucleotide and a phenylalanine-based compound are further added to the saturated solution, the mole ratio of the amounts of nicotinamide mononucleotide and the phenylalanine-based compound added to the saturated solution (nicotinamide mononucleotide:phenylalanine-based compound) may be 1:0.7 to 1:1.3, 1:0.75 to 1:1.2, or 1:0.8 to 1:1.1.

To the mixed solution, an auxiliary component such as an antioxidant, an ultraviolet absorber, a stabilizer, or the like may be added as necessary so far as these components do not disturb the formation of a crystalline complex.

In the step of precipitating a crystalline complex from the mixed solution, when the solvent of the mixed solution is a single solvent, crystallization is performed by cooling the mixed solution. When the solvent of the mixed solution is a mixed solvent of water and a water-miscible organic solvent, the water-miscible organic solvent functions as a poor solvent, so that crystallization can be performed without cooling, but it is preferable to cool the mixed solution for obtaining a crystalline complex having a desired crystal structure with high efficiency.

The cooling temperature of the mixed solution in the step of precipitating a crystalline complex may be higher than 0 ° C. and 20° C. or lower, 2° C. or higher and 15° C. or lower, or 3° C. or higher and 12° C. or lower. It is not preferable to cool the mixed solution to a temperature of 0 ° C. or lower, at which the mixed solution freezes, because this makes it impossible to obtain a desired crystal structure for the crystalline complex.

The cooling time of the mixed solution in the step of precipitating a crystalline complex may be 0.5 to 96 hours, 1 to 72 hours, or 3 to 60 hours.

In the cooling of the mixed solution in the step of precipitating a crystalline complex, the mixed solution may be stirred using a known or conventional device under known or conventional conditions, but it is also preferable to allow the mixed solution to stand without stirring.

The precipitated crystalline complex may be separated from the solvent by solid-liquid separation. Examples of the solid-liquid separation method include natural filtration, filtration under reduced pressure, filtration under pressure, and centrifugal filtration. The crystalline complex obtained by solid-liquid separation may be further subjected to a treatment such as washing, recrystallization, drying, or the like using a known or conventional device under known or conventional conditions.

The yield of the crystalline complex obtained by the production method according to one or more embodiments of the present invention may be 5 mol % or more, or 10 mol % or more, based on nicotinamide mononucleotide, and there is no particular upper limit to the yield, and it may be up to 100 mol %.

The crystalline complex according to one or more embodiments of the present invention can be used as a composition further containing other components depending on the application. The composition according to one or more embodiments of the present invention has safety and excellent stability that are derived from the crystalline complex contained therein.

Examples of other components include pharmaceutical components and food components, and these components may be contained in the composition in a known combination and at a known blending ratio.

The present application claims priority to Japanese Patent Application No. 2023-107092, filed on Jun. 29, 2023. The entire disclosure of Japanese Patent Application No. 2023-107092, filed on Jun. 29, 2023, is incorporated herein by reference in its entirety.

### EXAMPLES

Hereinafter, one or more embodiments of the present invention will be described in more detail with reference to Examples. However, one or more embodiments of the present invention are, of course, not limited to the following Examples, and it can be naturally carried out with appropriate modifications within the range consistent with the spirit described above and below, and all such embodiments are included within the technical scope of the present invention.

The structure of the crystalline complex was identified by measuring an X-ray diffraction pattern of a sample according to powder X-ray diffractometry. The conditions for performing the powder X-ray measurement were as follows:
Device: Mini Flex II manufactured by Rigaku Corporation
X-ray used: Cu-Kα ray
Intensity: 30 kV, 15 mA
Angle: 2θ=2 to 60°
Scanning rate: 2°/min
Divergence Slit (DS): 1.25°
Scattering Slit (SS): 1.25°
Receiving Slit (RS): 0.3 mm

The content of nicotinamide mononucleotide was measured by high-performance liquid chromatography (HPLC). The HPLC conditions were as follows:
Column: COSMOSIL 3PBr 3.0×150 mm (manufactured by Nacalai Tesque, Inc.)
Column temperature: 40° C.
Mobile phase: 20 mM ammonium formate/MeOH=95/5
Flow rate: 0.4 mL/min
Detector: UV 260 nm
Sample injection volume: 5 μL (in water)

### Example 1

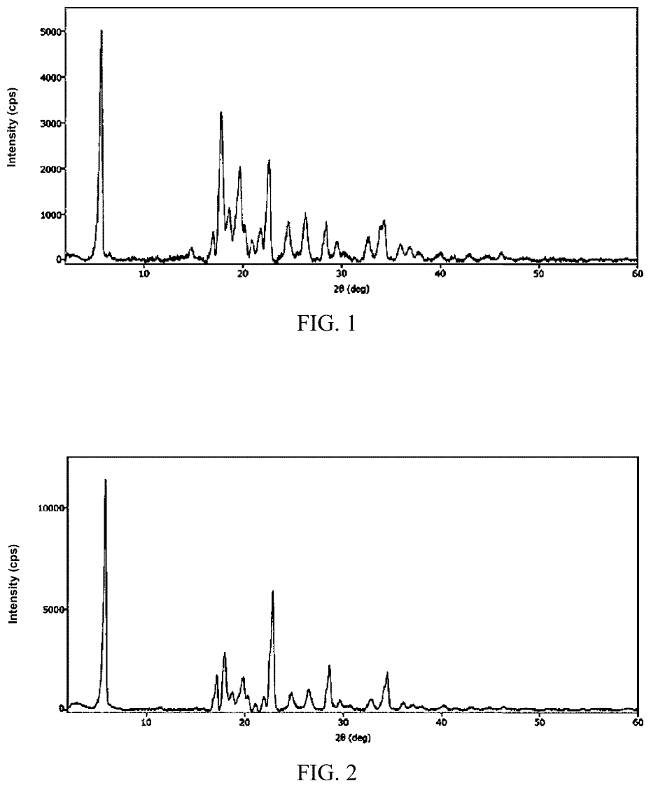

In 200 ml of water at 55° C., 6.7 g (20 mmol) of nicotinamide mononucleotide and 3.4 g (20 mmol) of L-phenylalanine were dissolved. To this solution, 200 mL of acetonitrile was added dropwise over 100 minutes, and then the mixture was cooled to 4° C. at a rate of 3° C./hr. The resulting slurry was evaporated to dryness at 30° C. under reduced pressure using a vacuum pump, and then the residue was washed with acetonitrile, filtered, and dried to obtain 1.23 g of a white crystal. The obtained crystal was analyzed by powder X-ray diffractometry. As a result, specific peaks were observed at 2θ (=0.2°)=19.68°, 26.35°, and 32.70°, which were not observed in the raw materials, nicotinamide mononucleotide and L-phenylalanine, and it was confirmed that a crystalline complex having a crystal structure different from those of the raw materials had been formed. FIG. 1 shows the powder X-ray diffraction diagram of this crystal. The obtained crystalline complex maintained its crystal structure without deliquescing even after being left in a room environment for 24 hours.

### Example 2

In 200 ml of water at 55° C., 6.7 g (20 mmol) of nicotinamide mononucleotide and 3.4 g (20 mmol) of L-phenylalanine were dissolved. To this solution, 200 ml of acetonitrile was added dropwise over 113 minutes, and then the mixture was cooled to 4° C. at a rate of 3° C./hr. The resulting slurry was concentrated at 30° C. under reduced pressure using a vacuum pump, and after adding 200 mL of acetonitrile once during the concentration, the mixture was concentrated again and dried. Then, the residue was washed with acetonitrile, filtered, and dried to obtain 2.25 g of a white crystal. The obtained crystal was analyzed by powder X-ray diffractometry. As a result, as in Example 1, specific peaks were observed at 2θ (±0.2°)=19.79°, 26.49°, and 32.83°, which were not observed in the raw materials, nicotinamide mononucleotide and L-phenylalanine, and it was confirmed that a crystalline complex having a crystal structure different from those of the raw materials had been formed with good reproducibility. FIG. 2 shows the powder X-ray diffraction diagram of this crystal. The obtained crystalline complex maintained its crystal structure without deliquescing even after being left in a room environment for 24 hours.

### Example 3

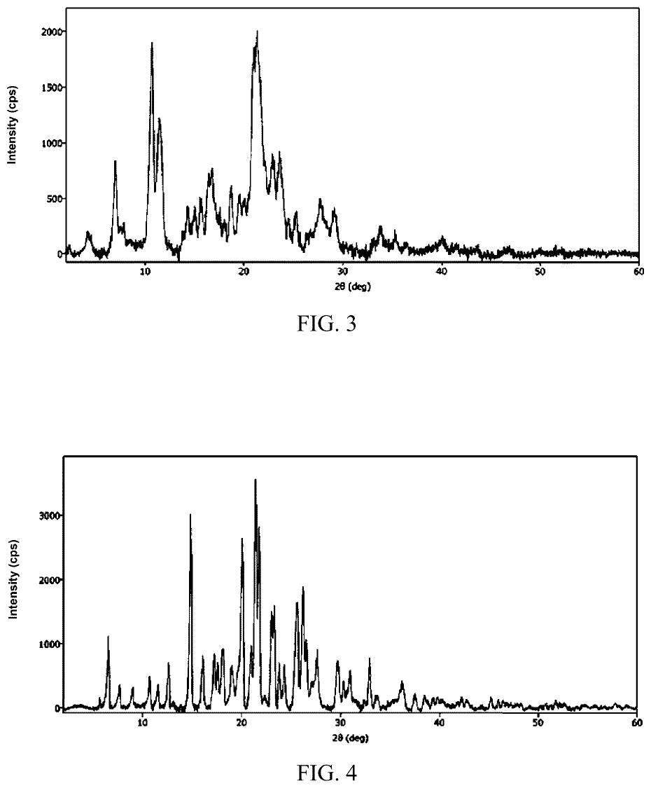

In 200 mL of water at 55° C., 6.7 g (20 mmol) of nicotinamide mononucleotide and 5.89 g (20 mmol) of aspartame were dissolved. To this solution, 200 mL of acetonitrile was added dropwise over 100 minutes, and then the mixture was cooled to 4° C. at a rate of 3° C./hr. The resulting slurry was concentrated at 30° C. under reduced pressure, filtered, and dried to obtain 3.10 g of a white crystal. The obtained crystal was analyzed by powder X-ray diffractometry. As a result, specific peaks were observed at 2θ (±0.2°)=7.05°, 10.70°, 14.44°, and 29.10°, which were not observed in the raw materials, nicotinamide mononucleotide and aspartame, and it was confirmed that a crystalline complex having a crystal structure different from those of the raw materials had been formed. FIG. 3 shows the powder X-ray diffraction diagram of this crystal. The obtained crystalline complex maintained its crystal structure without deliquescing even after being left in a room environment for 24 hours.

### Example 4

At 25° C., 4.0 g of nicotinamide mononucleotide was thoroughly dissolved in 50 mL of a mixed solution of acetonitrile:water=1:1, and after the undissolved residue was filtered off, 1.0 g of L-phenylalanine was added to the resulting solution and thoroughly dissolved at 25° C. The undissolved residue was filtered again, and to the resulting solution (hereinafter referred to as the saturated solution), 1.67 g (5 mmol) of nicotinamide mononucleotide and 0.83 g (5 mmol) of L-phenylalanine were added. This mixture was cooled to 6° C. at a rate of 3° C./hr and then maintained at the same temperature for 2 days with stirring. The resulting slurry was filtered and dried at 30° C. under reduced pressure using a vacuum pump to obtain 2.16 g of a white crystal. The obtained crystal was analyzed by powder X-ray diffractometry. As a result, specific peaks were observed at 2θ (±0.2°)=19.77°, 26.25°, and 32.95°, which were not observed in the raw materials, nicotinamide mononucleotide and L-phenylalanine, and it was confirmed that a crystalline complex having a crystal structure different from those of the raw materials had been formed. FIG. 4 shows the powder X-ray diffraction diagram of this crystal. The amount of nicotinamide mononucleotide contained in the crystal was measured by HPLC and found to be 55.4 mol %, and it was suggested that a crystalline complex with a nicotinamide mononucleotide:phenylalanine ratio of 1:0.8 had been formed. Furthermore, the obtained crystalline complex maintained its crystal structure without deliquescing even after being left in a room environment for 24 hours.

### ((Thermal Stability Test))

The crystalline complex obtained in Example 4 and, for comparison, nicotinamide mononucleotide powder were each heated at 150° C. for 1 hour. The content of nicotinamide mononucleotide each before and after heating was measured by HPLC, and the thermal stability was evaluated based on the residual amount of nicotinamide mononucleotide after heating relative to the amount of nicotinamide mononucleotide before heating. As a result, the content of nicotinamide mononucleotide in the nicotinamide mononucleotide powder was reduced to 81 mol % by thermal decomposition, whereas the residual amount of nicotinamide mononucleotide in the crystalline complex obtained in Example 4 was 90 mol % after heating, and the crystalline complex exhibited improved thermal stability.

### Comparative Example 1

In a container containing 80 ml of water, 1 g (3 mmol) of nicotinamide mononucleotide and 0.5 g (3 mmol) of L-phenylalanine were added. The container was cooled to freeze the contents, and then connected to a freeze dryer for freeze-drying to obtain a solid. The obtained solid was analyzed by powder X-ray diffractometry. As a result, the X-ray diffraction pattern was different from the patterns of the crystals obtained in Examples 1, 2, and 4, and peaks specific to the crystalline complex of one or more embodiments of the present invention were not observed. Moreover, only very weak diffraction peaks were observed, suggesting that the solid had low crystallinity. The obtained solid was hygroscopic, and when left in a room environment, it immediately absorbed moisture and became sticky over time.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A crystalline complex comprising:
a nicotinamide mononucleotide; and
a phenylalanine-based compound,
wherein the phenylalanine-based compound is L-phenylalanine, and the crystalline complex has peaks at diffraction angles (2θ) of 19.7±0.2°, 26.4±0.2°, and 32.8±0.2° in a diffraction pattern of powder X-ray diffraction measured with a Cu-Kα ray as an X-ray source, or
wherein the phenylalanine-based compound is aspartame, and the crystalline complex has peaks at diffraction angles (2θ) of 7.0±0.2°, 10.7±0.2°, 14.4±0.2°, and 29.1±0.2° in the diffraction pattern of powder X-ray diffraction measured with the Cu-Kα ray as the X-ray source.

2. The crystalline complex according to claim 1, wherein a mole ratio of the nicotinamide mononucleotide and the phenylalanine-based compound (nicotinamide mononucleotide:phenylalanine-based compound) in the crystalline complex is 1:0.7 to 1:1.3.

3. The crystalline complex according to claim 1, wherein the phenylalanine-based compound is L-phenylalanine, and the crystalline complex has at least one selected from the following characteristics (i) to (iii) in the diffraction pattern of powder X-ray diffraction measured with the Cu-Kα ray as the X-ray source:
(i) a ratio of peak intensities at diffraction angles (2θ) of 19.7±0.2° and 26.4±0.2° (peak intensity at 26.4±0.2°/peak intensity at 19.7±0.2°) is 0.35 or more and 0.90 or less;
(ii) a ratio of peak intensities at diffraction angles (2θ) of 19.7±0.2° and 32.8±0.2° (peak intensity at 32.8±0.2°/peak intensity at 19.7±0.2°) is 0.10 or more and 0.60 or less; and
(iii) a ratio of peak intensities at diffraction angles (2θ) of 26.4±0.2° and 32.8±0.2° (peak intensity at 32.8±0.2°/peak intensity at 26.4±0.2°) is 0.30 or more and 0.80 or less.

4. The crystalline complex according to claim 1, wherein the phenylalanine-based compound is aspartame, and the crystalline complex has at least one selected from the following characteristics (a) to (f) in the diffraction pattern of powder X-ray diffraction measured with the Cu-Kα ray as the X-ray source:
(a) a ratio of peak intensities at diffraction angles (2θ) of 10.7±0.2° and 7.0±0.2° (peak intensity at 7.0±0.2°/peak intensity at 10.7±0.2°) is 0.30 or more and 0.70 or less;
(b) a ratio of peak intensities at diffraction angles (2θ) of 10.7±0.2° and 14.4±0.2° (peak intensity at 14.4±0.2°/peak intensity at 10.7±0.2°) is 0.05 or more and 0.50 or less;
(c) a ratio of peak intensities at diffraction angles (2θ) of 10.7±0.2° and 29.1±0.2° (peak intensity at 29.1±0.2°/peak intensity at 10.7±0.2°) is 0.05 or more and 0.50 or less;
(d) a ratio of peak intensities at diffraction angles (2θ) of 7.0±0.2° and 14.4±0.2° (peak intensity at 14.4±0.2°/peak intensity at 7.0±0.2°) is 0.30 or more and 0.80 or less;
(e) a ratio of peak intensities at diffraction angles (2θ) of 7.0±0.2° and 29.1±0.2° (peak intensity at 29.1±0.2°/peak intensity at 7.0±0.2°) is 0.30 or more and 0.70 or less; and
(f) a ratio of peak intensities at diffraction angles (2θ) of 14.4±0.2° and 29.1±0.2° (peak intensity at 29.1±0.2°/peak intensity at 14.4±0.2°) is 0.50 or more and 1.05 or less.

5. A composition comprising the crystalline complex according to claim 1.

6. A method for producing the crystalline complex according to claim 1, the method comprising precipitating the crystalline complex from a mixed solution, wherein the nicotinamide mononucleotide and the phenylalanine-based compound are dissolved in the mixed solution.

7. The method according to claim 6, comprising precipitating the crystalline complex of the nicotinamide mononucleotide and the phenylalanine-based compound from a mixed solvent of water and a water-miscible organic solvent.

8. The method according to claim 6, wherein a mole ratio of the nicotinamide mononucleotide to the phenylalanine-based compound in the mixed solution (nicotinamide mononucleotide:phenylalanine-based compound) is 1:0.7 to 1:1.3.

9. The method according to claim 7, wherein the water-miscible organic solvent comprises at least one selected from the group consisting of monohydric alcohols, ketones, and nitriles.

10. The method according to claim 7, wherein, with respect to a mixing ratio of the water to the water-miscible organic solvent in the mixed solvent, an amount of the water-miscible organic solvent relative to 1 volume of the water is 0.5 volumes or more and 50 volumes or less.
